(19) United States
(12) Patent Application Publication
(10) Pub. No.: US 2020/0257910 A1
(43) Pub. Date: Aug. 13, 2020

(54) METHOD FOR AUTOMATICALLY IDENTIFYING PARKING AREAS AND/OR NON-PARKING AREAS

(71) Applicant: Robert Bosch GmbH, Stuttgart (DE)

(72) Inventors: Philipp Mayer, Ho Chi Minh City (VN); Daniel Zaum, Sarstedt (DE); Thorben Schick, Hardegsen (DE)

(21) Appl. No.: 16/649,540

(22) PCT Filed: Aug. 22, 2018
(86) PCT No.: PCT/EP2018/072615

§ 371 Date: Mar. 20, 2020

(30) Foreign Application Priority Data
Sep. 27, 2017 (DE) 10 2017 217 169.3

(51) Int. Cl. G06K 9/00; G08G 1/01; G08G 1/14

(52) U.S. Cl. CPC G06K 9/00812; G08G 1/147; G08G 1/0112; G08G 1/0129

(57) ABSTRACT

A method for automatically identifying parking areas and/or non-parking areas, including: S1 carrying out multiple passes, however at least two passes, through at least one road section with at least one measuring vehicle; S2 detecting parking space data along the road section during each pass with the aid of at least one sensor of the at least one measuring vehicle, the parking space data including parking space detections and respectively assigned location and time information; S3 accumulating the parking space data detected during each pass in a data set; S4 ascertaining a temporal change rate of parking space detections based on the data set; and S5 ascertaining valid parking areas and/or non-parking areas along the road section on the basis of the temporal change rate of different parking space detections. Also described are a corresponding device for automatically identifying parking areas and/or non-parking areas system and a computer program.

### FIELD OF THE INVENTION

The present invention relates to a method for automatically identifying parking areas and/or non-parking areas and a device and a computer program.

### BACKGROUND INFORMATION

The present invention relates to a method for automatically identifying parking areas and/or non-parking areas. Additional aspects of the present invention relate to a computer program, a central computer unit and a device which is configured to carry out the method.

In view of an increase in the level of automation of vehicles, increasingly more complex driver assistance systems are used. A large number of sensors in the vehicle, which facilitate an exact detection of the vehicle surroundings, are necessary for such driver assistance systems and functions, such as highly automated driving or fully automated driving.

Methods for automatically identifying parking areas and/or non-parking areas are included, among other things, for detecting the vehicle surroundings. In the automotive sector, additional different driver assistance systems are used, which are to support the driver when carrying out different driving maneuvers. These include, for example, parking assistance systems, which detect the surroundings with the aid of sensors assigned to the vehicle, ascertain potential parking areas in the surroundings, and support the driver during parking. Furthermore, driver assistance systems are known in the related art, which support the driver when locating suitable free parking spaces.

In the following, higher automated is understood to be all those degrees of automation that correspond to an automated longitudinal and transverse guiding with increasing system responsibility, e.g., highly and fully automated driving, within the sense of the Federal Highway Research Institute (BASt).

In the related art, different methods are known for ascertaining distances of a vehicle to objects with the aid of distance-based sensors (e.g., ultrasonic, radar, laser, video, LIDAR sensors).

A transmission of parking space data to a server is discussed, for example, in patent documents DE 10 2004 062 021 A1, DE 10 2009 028 024 A1, and DE 10 2008 028 550 A1.

Patent document DE 10 2004 062 021 A1 discusses a system for using free parking spaces. It is thereby provided that road users ascertain the location and dimension of free parking spaces when passing by, and transmit the data thus collected to a control center. These data are provided by the control center to road users seeking parking spaces.

A car-park routing system and a navigation device for navigating a vehicle seeking parking to a free parking space are discussed in DE 10 2009 028 024 A1. Information about available, free parking spaces is thereby gathered by vehicles located in traffic, the information is transmitted directly to the vehicle seeking parking or indirectly via a control center to the vehicle seeking parking.

### SUMMARY OF THE INVENTION

It is one object of the present invention to provide an improved method for automatically identifying parking areas and/or non-parking areas.

This problem may be solved with the aid of the respective subject matter of the descriptions herein. Advantageous embodiments of the present invention are the subject matter of the respective further descriptions herein.

According to one aspect of the present invention, a method for automatically identifying parking areas and/or non-parking areas includes the following steps:

S1 carrying out multiple passes, however at least two passes, through at least one road section with at least one measuring vehicle;

S2 detecting parking space data along the road section during each pass with the aid of at least one sensor of the at least one measuring vehicle, the parking space data including parking space detections and respectively assigned location and time information;

S3 accumulating the parking space data detected during each pass in a data set;

S4 ascertaining a temporal change rate of parking space detections based on the data set; and

S5 ascertaining valid parking areas and/or non-parking areas along the road section on the basis of the temporal change rate of different parking space detections.

In this way, parking spaces between two vehicles are continuously measured and detected by the measuring vehicle in step S1, parking space data being detected along the road section during each pass with the aid of at least one sensor in step S2, the parking space data including parking space detections and respective location and time information.

Another advantageous refinement of the method provides that the traveling of the road section is carried out in different driving directions, the parking space data along the road section being correlated to the different driving directions during each pass. In this way, for example, the ascertainment of parking space data may be advantageously carried out more precisely on the basis of the traveling of the road section in opposite directions.

The parking space data may be assigned to so-called bins, a bin designating a defined section along the road section, and the assignment of a parking space detection to a bin being carried out based on the location information assigned to the respective parking space detection.

The length of the bin may be freely configurable. Thus, for example, an average vehicle length of five meters may be selected as the length. Another advantageous refinement of the method is thereby advantageous, in which the parking space data is ascertained for a defined length of the road section. In this way, temporal change rates of the parking space detections may be set for selectively selected areas.

The temporal change rate of the parking space detections according to step S4 is jointly ascertained for parking space detections and combined in one bin, so that, as a result of this ascertainment, a temporal change rate, which results from the temporal change rates of the parking space detections combined in the bin, is assigned to each bin.

The temporal change rate thereby represents the degree of temporal stability of space occupations, for example, parked cars, at temporally constant events, as are typical for non-parking areas, the temporal change rate being low, and in the case of parking areas, which are subject to frequent occupancy change, the temporal change rate being high.

For the next steps, it is advantageously provided in one specific embodiment of the present invention that the step of ascertaining valid parking areas and non-parking areas along the road section (S5) is carried out based on the temporal change rate of the respective bins, a respective bin being classified as a parking area or non-parking area based on the temporal change rate of parking space detections assigned to it.

Thus, for example, the temporal change rate may be normalized by the number of passes through a road. If the temporal change rate is low, then a parking space detection is present in this bin for almost every pass. If the temporal change rate is high, then parking space detections occur only sporadically and temporally irregularly. Non-parking areas (e.g., a driveway, a no parking zone, or a tree area) and parking areas may be correspondingly ascertained by way of this method and separated from one another.

In one specific embodiment, the parking space detections and the parking areas and/or non-parking areas are processed into a digital parking space map, for example, a driveway, a no parking zone, a T intersection and/or a tree area being able to be registered as non-parking areas.

In another specific embodiment of the present invention, the method includes that the sensors used in step S2 to detect parking space data function according to a distance-based measuring method.

For the next steps, one specific embodiment of the present invention advantageously provides that the accumulation carried out in step S3 takes place at least partially locally in the measuring vehicle and/or at least partially in a central server device. In this way, a large amount of historical data, which represent highly up-to-date and accurate parking space data, may be aggregated long-term on the server device.

The ascertained temporal change rates of the parking space detections are advantageously used to select a parameterization of cluster-based methods for learning parking areas and non-parking areas.

Another subject matter of the present invention is a device for automatically identifying parking areas and/or non-parking areas, including a measuring vehicle with at least one sensor, data being detectable with the aid of the sensor regarding a parking space along the road section during each pass, further including a control unit, the control unit being configured to carry out a method as described herein.

The measuring vehicle may include at least one communication unit for transmitting data to a server device.

In one particularly specific embodiment, the sensor is configured as an ultrasonic sensor or as a radar sensor.

Furthermore, a computer program, including programming code for carrying out the method as described herein, when the computer program is run on a device for automatically identifying parking areas and/or non-parking areas, also forms a subject matter of the present invention.

Although the present invention is subsequently described primarily in conjunction with passenger vehicles, it is not limited thereto, but instead may be used with any type of vehicle, commercial vehicles and/or passenger vehicles.

Additional features, application options, and advantages of the present invention arise from the subsequent description of one exemplary embodiment of the present invention, which is depicted in the FIGURE. It should thereby be taken into consideration that the features depicted have only a descriptive character and may also be used in combination with features of other refinements described above and are not conceived of as limiting the present invention in any way.

The present invention will be subsequently described in greater detail by way of one exemplary embodiment, identical reference numerals being used for identical features.

### BRIEF DESCRIPTION OF THE DRAWING

FIG. 1 shows a schematic view of a road section including assigned parking space detections and classification of the same into bins.

### DETAILED DESCRIPTION

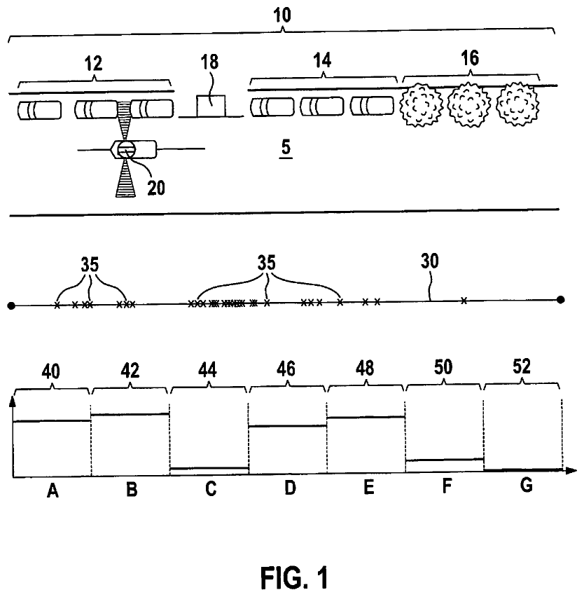

FIG. 1 shows in its upper area a road section 10 including a lane 5. Parked vehicles are located in certain areas 12 and 14 at the edge of lane 5. A tree area is situated in an area 16 on the shoulder, and a driveway opens onto lane 5 in an area 18. While areas 12 and 14 are parking areas, areas 16 and 18 are non-parking areas.

The FIGURE additionally shows a measuring vehicle 20, which includes at least one sensor (not depicted in greater detail) which is suited for recording parking space data. The sensor may in particular be a sensor that functions according to a distance-based measuring method, for example, a radar or ultrasonic sensor.

A step S1 of the method according to the present invention includes that measuring vehicle 20 carries out multiple passes, however at least two passes, through road section 10.

In a step S2, parking space data are detected during each pass along road section 10 with the aid of the at least one sensor, among other things, the parking space data including parking space detections and respectively assigned location and time information. Location information may here be, for example, a dynamic coordinate running along the road section or a piece of GPS information. A piece of time information may be, for example, the sequential number of the passes of measuring vehicle 20 through road section 10 or a time at which the parking space detection was carried out.

The measuring of the road section by the sensor, i.e., the recording of the parking space data, may be carried out continuously or virtually continuously.

The expression “parking space detection” hereby includes both pieces of information, that a parking space was detected in an edge area of road section 10 at a certain location and also the information that no parking spaces were detected there.

In a step S3, the parking space data detected during each pass are accumulated in a data set. This is symbolized in FIG. 1 in the center area of the illustration by a horizontal line 30, which depicts a running coordinate of road section 10 and points 35 situated thereon. In the FIGURE, each point stands for a parking space detection. The depicted parking space detections result from multiple passes made by one or multiple measuring vehicles 20. The parking space detections are processed into a digital map using the location information, for which reason the parking space detections in FIG. 1 are designated as “map matched.” The data set may be stored in a suitable memory of measuring vehicle 20 or in a central server computer.

An increase of parking space detections in area 18, thus the driveway is apparent, since the area is generally free and is detected during approximately each pass. The parking space detections are distributed based on the positional inaccuracies, which may be based, for example, on imprecise GPS.

An approximate increase in parking space detections is present in areas 12 and 14, since these areas, which are parking areas, are occupied most times by parked vehicles, however, are also occasionally free. A negligible increase in parking space detections is apparent in area 16, thus in the area of the tree area. These parking space detections may result, for example, from sporadically occurring misdetections caused by the device.

In a step S4 of the present invention, temporal change rates of parking space detections are ascertained based on the data set. For this purpose, bundles of parking space detections are sorted into so-called “bins” 40, 42, 44, 46, 48, 50, 52 on the basis of their assigned location information, which is depicted in the lower part of FIG. 1. A bin 40, 42, 44, 46, 48, 50, 52 corresponds to a road section of a certain length along road section 10. A bin 40, 42, 44, 46, 48, 50, 52 is principally freely determinable and may have, for example, a length of 5 m, which corresponds to an average vehicle length. The assignment of a parking space detection to a bin may be carried out, for example, on the basis of the location information assigned to the respective parking space detection.

In another step S5 of the present invention, valid parking areas and/or non-parking areas are ascertained along the road section on the basis of the temporal change rate of different parking space detections. The temporal change rate is formed from the temporal stability of events. In the case of regular, temporally repeating events, the temporal change rate is low. In the case of temporally sporadic events, the temporal change rate is high. The temporal change rate is normalized by the number of passes through a road.

In the example depicted in FIG. 1, the temporal change rate in bin 44 is low, since a parking space detection is carried out in this bin in almost every pass. The temporal change rate in bins 40, 42, 46, and 48 is high, a since parking space detections occur only sporadically and temporally irregularly. The temporal change rate is low in bin 50, since a parking space detection in this bin occurs in almost none of the passes. The temporal change rate in bin 52 is equal to zero, since no single parking space detection occurs in this bin.

In the example of FIG. 1, the temporal change rate of the parking space detections according to step S4 is thus jointly ascertained for parking space detections combined in a bin, so that a temporal change rate, which results from the temporal change rate of the parking space detections combined in the bin, is assigned to each bin as a result of this ascertainment.

Existing non-parking areas, areas 16 and 18 in the present case, and presently free parking areas, areas 12 and 14 in the present case, may now be ascertained and separated from one another by assigning bins 40, 42, 44, 46, 48, 50, 52 to areas 12, 14, 16, and 18.

According to one specific embodiment of the present invention, the ascertainment of valid parking areas and/or non-parking areas along the road section is carried out in step S5 on the basis of the temporal change rate of the respective bins, a respective bin being classified as a parking area or as a non-parking area on the basis of the temporal change rate of parking space detections assigned to it.

Using this information, a digital parking space map may be generated including information about parking areas, where vehicles are allowed to park, and also non-parking areas, where parking is not permitted.

The results of the temporal change rate of the parking space detections may advantageously be used to select the parameterization of cluster-based methods for learning parking areas and non-parking areas. At only a small interval in the temporal change rate between the bins, the occurrence probability for detecting parking areas versus non-parking areas is approximately equal, and the parameters of a clustering method should be selected as correspondingly conservative (e.g., a high expected density for density-based methods). Conversely, in the case of significant differences in the temporal change rate, a high occupancy rate of the parking areas may be assumed and the clustering may correspondingly be parameterized more broadly.

The present invention is not limited to the described and depicted exemplary embodiment. Instead, it also includes all refinements by those skilled in the art within the scope of the present invention defined herein.

In addition to the described and represented exemplary embodiments, additional exemplary embodiments are conceivable which may include further modifications and combinations of features.

1-12. (canceled)

13. A method for automatically identifying parking areas and/or non-parking areas, the method comprising:
carrying out at least two passes through at least one road section with at least one measuring vehicle;
detecting parking space data along the road section during each pass with at least one sensor of the at least one measuring vehicle, wherein the parking space data includes parking space detections and respectively assigned location and time information;
accumulating the parking space data detected during each pass in a data set;
ascertaining a temporal change rate of parking space detections based on the data set; and
ascertaining valid parking areas and/or non-parking areas along the road section on the basis of the temporal change rate of different parking space detections.

14. The method of claim 13, wherein the parking space data are assigned to bins, one of the bins designating a defined section along the road section, and the assignment of a parking space detection to a bin taking place in particular based on the location information assigned to the respective parking space detection.

15. The method of claim 14, wherein the temporal change rate of the parking space detections according to ascertaining the temporal change rate is jointly ascertained for parking space detections combined into one bin, so that a temporal change rate, which results from the temporal change rate in the parking space detections combined in the bin, is assigned to each of the bins as a result of this ascertainment.

16. The method of claim 15, wherein the ascertainment of valid parking areas and/or non-parking areas along the road section takes place based on the temporal change rate of the respective bins, a respective one of the bins being classified due to their assigned temporal change rate of parking space detections as a parking area or a non-parking area.

17. The method of claim 13, wherein the parking space detections and the parking areas and/or non-parking areas are processed into a digital parking space map.

18. The method of claim 13, wherein the sensor used, in the detecting, for detecting parking space data functions according to a distance-based measuring method.

19. The method of claim 13, wherein the accumulation carried out in the accumulating of the parking space data takes place at least partially locally in the measuring vehicle and/or at least partially in a central server device.

20. The method of claim 13, wherein the ascertained temporal change rates of the parking space detections are used to select a parameterization of cluster-based methods for learning parking areas and non-parking areas.

21. A device for automatically identifying parking areas and/or non-parking areas, comprising:
at least one measuring vehicle with at least one sensor configured to detect data regarding a parking space along the road section during each pass; and
a control unit configured for automatically identifying the parking areas and/or the non-parking areas, by performing the following:
carrying out at least two passes, through at least one road section with the at least one measuring vehicle;
detecting parking space data along the road section during each pass with at least one sensor of the at least one measuring vehicle, wherein the parking space data includes parking space detections and respectively assigned location and time information;
accumulating the parking space data detected during each pass in a data set;
ascertaining a temporal change rate of parking space detections based on the data set; and
ascertaining valid parking areas and/or non-parking areas along the road section on the basis of the temporal change rate of different parking space detections.

22. The device of claim 21, wherein the measuring vehicle includes at least one communication unit for transmitting data to a server device.

23. The device of claim 21, wherein the sensor is configured as an ultrasonic sensor or as a radar sensor.

24. A non-transitory computer readable medium having a computer program, which is executable by a processor, comprising:
a programming code arrangement having programming code for automatically identifying parking areas and/or non-parking areas, by performing the following:
carrying out at least two passes, through at least one road section with at least one measuring vehicle;
detecting parking space data along the road section during each pass with at least one sensor of the at least one measuring vehicle, wherein the parking space data includes parking space detections and respectively assigned location and time information;
accumulating the parking space data detected during each pass in a data set;
ascertaining a temporal change rate of parking space detections based on the data set; and
ascertaining valid parking areas and/or non-parking areas along the road section on the basis of the temporal change rate of different parking space detections.
